(19) United States
(12) Patent Application Publication
(10) Pub. No.: US 2012/0067921 A1
(43) Pub. Date: Mar. 22, 2012

(54) LIQUID DISPENSER

(76) Inventor: Scott Shippen, Alpine, UT (US)

(21) Appl. No.: 13/235,994

(22) Filed: Sep. 19, 2011

Related U.S. Application Data
(60) Provisional application No. 61/384,195, filed on Sep. 17, 2010.

(51) Int. Cl. B67D 7/78; B67D 7/06

(52) U.S. Cl. 222/144; 222/146.6; 222/181.1; 222/185.1

(57) ABSTRACT

A system, apparatus and methods for dispensing liquids is disclosed. The dispenser device and system may comprise an on-board ice and cup storage unit. The device and system may include a stand with a drip basin; a rack accommodating a cup holder and an inverted container holder/fitting for holding multiple containers, such as 2 liter bottles, with dispensing valves; and an ice bin located within the rack, which may comprise partially contoured sides around each container and around the cup holder. Dispensing valves may be lever-actuated, simulating a soda fountain delivery system. The device and system may be disassembled and nested for easy transport or storage.

### CROSS-REFERENCE TO RELATED APPLICATIONS

This application claims the benefit of U.S. Provisional Application No. 61/384,195, filed Sep. 17, 2010, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

The disclosure relates generally to liquid dispensing and more particularly, but not necessarily entirely, to dispensing beverages from standardized containers in a controllable organized manner.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out herein.

### SUMMARY OF THE DISCLOSURE

An embodiment of the disclosure may comprise a carousel dispenser configured to retain containers of liquid, wherein the dispenser may comprise a stand, a rotating rack, dispensing valves, and a container for holding ice. An embodiment may comprise a drip basin for catching stray liquids. An embodiment may be configured for disassembly and reassembly for easy transport and storage. An embodiment may further comprise a cup holder. An embodiment may be configured to use standard two liter beverage containers or other sized containers. An embodiment may comprise screw-on dispensing valves. An embodiment may comprise a rack configured to hold a plurality of liquid containers.

An embodiment of the disclosure may comprise a dispenser head that can be removed from the assembly without disassembly, allowing easy and quick liquid container changes.

An embodiment of the disclosure may comprise an ice bin that maybe removed from a rack assembly without disassembly of the rack assembly, allowing easy and quick servicing.

An embodiment of the disclosure may comprise a stand configured as a single post design that fits into a corresponding female feature of the rack.

An embodiment of the disclosure may comprise a stand that is configured to both support an upper assembly and allow the upper assembly to rotate relative to the stand. An embodiment may comprise a bushing that separates the stand from the upper assembly thereby reducing friction during rotation.

### BRIEF DESCRIPTION OF THE DRAWINGS

The features and advantages of the disclosure will become apparent from a consideration of the subsequent detailed description presented in connection with the accompanying drawings in which:

FIG. 1 is an illustration of an embodiment comprising some of the features of the disclosure and made in accordance with the teachings and principles of the disclosure;

FIG. 2 is an illustration of an embodiment comprising some of the features of the disclosure and made in accordance with the teachings and principles of the disclosure;

FIG. 3 is an illustration of an embodiment comprising some of the features of the disclosure and made in accordance with the teachings and principles of the disclosure;

FIG. 4 is an illustration of an embodiment comprising some of the features of the disclosure and made in accordance with the teachings and principles of the disclosure;

FIG. 5 is an illustration of an embodiment comprising some of the features of the disclosure and made in accordance with the teachings and principles of the disclosure; FIG. 6 is an illustration of an embodiment comprising some of the features of the disclosure and made in accordance with the teachings and principles of the disclosure;

FIG. 7 is an illustration of an embodiment comprising some of the features of the disclosure and made in accordance with the teachings and principles of the disclosure;

FIG. 8 is an illustration of an embodiment comprising some of the features of the disclosure and made in accordance with the teachings and principles of the disclosure;

FIG. 9 is an illustration of an embodiment comprising some of the features of the disclosure and made in accordance with the teachings and principles of the disclosure;

FIG. 10 is an illustration of an embodiment comprising some of the features of the disclosure and made in accordance with the teachings and principles of the disclosure;

FIG. 11 is an illustration of an embodiment comprising some of the features of the disclosure and made in accordance with the teachings and principles of the disclosure;

FIG. 12 is an illustration of an embodiment comprising some of the features of the disclosure and made in accordance with the teachings and principles of the disclosure;

FIG. 13 is an illustration of an embodiment comprising some of the features of the disclosure and made in accordance with the teachings and principles of the disclosure;

FIG. 14 is an illustration of an embodiment comprising some of the features of the disclosure and made in accordance with the teachings and principles of the disclosure;

FIG. 15 is an illustration of an embodiment comprising some of the features of the disclosure and made in accordance with the teachings and principles of the disclosure;

FIG. 16 is an illustration of an embodiment comprising some of the features of the disclosure and made in accordance with the teachings and principles of the disclosure;

FIG. 17 is an illustration of an embodiment comprising some of the features of the disclosure and made in accordance with the teachings and principles of the disclosure; and

FIG. 18 is an illustration of an embodiment comprising some of the features of the disclosure and made in accordance with the teachings and principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the devices, systems, methods and processes for providing and reclaiming single use imaging devices are disclosed and described, it is to be understood that this disclosure is not limited to the particular embodiments, configurations, or process steps disclosed herein as such embodiments, configurations, or process steps may vary somewhat. It is also to be understood that the terminology employed herein is used for the purpose of describing particular embodiments only and is not intended to be limiting since the scope of the disclosure will be limited only by the claims, if any, and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

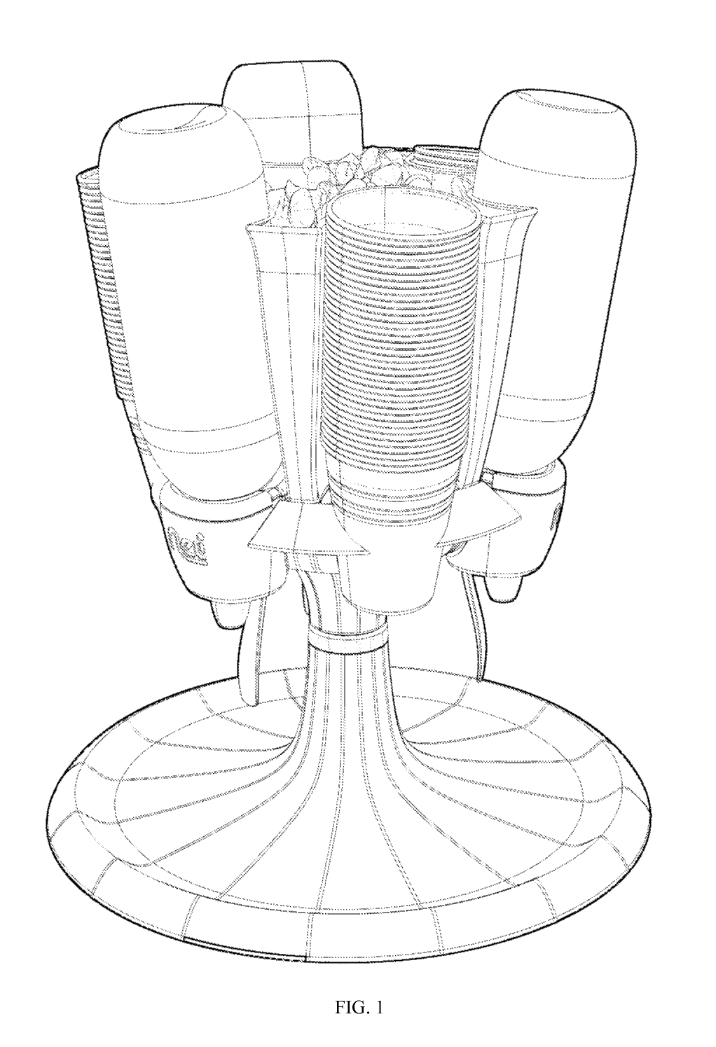

With reference primarily to FIG. 1, an embodiment of the features of the disclosure will be discussed generally. FIG. 1 illustrates a system and apparatus for dispensing fluids. Illustrated in the figure are a plurality of liquid containers mounted in a rack. The rack may also be configured to hold cups. The rack may be configured to rotate relative to a base to which it may be rotatably attached. The apparatus may also comprise a bin for holding ice. The ice bin may also be configured to cool the liquid containers by its close proximity to the liquid containers. The bin maybe, for example, made of a metal, polymeric or other material suitable for use as a bin. The apparatus may further comprise dispensing valves for controlling the flow of fluids from the liquid containers. The containers may be shaped and sized as standard and ubiquitous beverage containers, such as two liter bottles or other sized containers suitable for beverages. The dispensing valves may be configured with corresponding threads to attach and seal onto threads of the liquid containers. The dispensing valves may be friction fit or attached to the liquid containers by other means suitable in the art.

Referring now to FIG. 6, wherein an apparatus that has at least one empty space for receiving a container therein is shown. The apparatus may comprise a base, a rack, a head assembly or dispensing valve, and an ice bowl. The features of the apparatus may be assembled and utilized together as shown in the figure and as described herein.

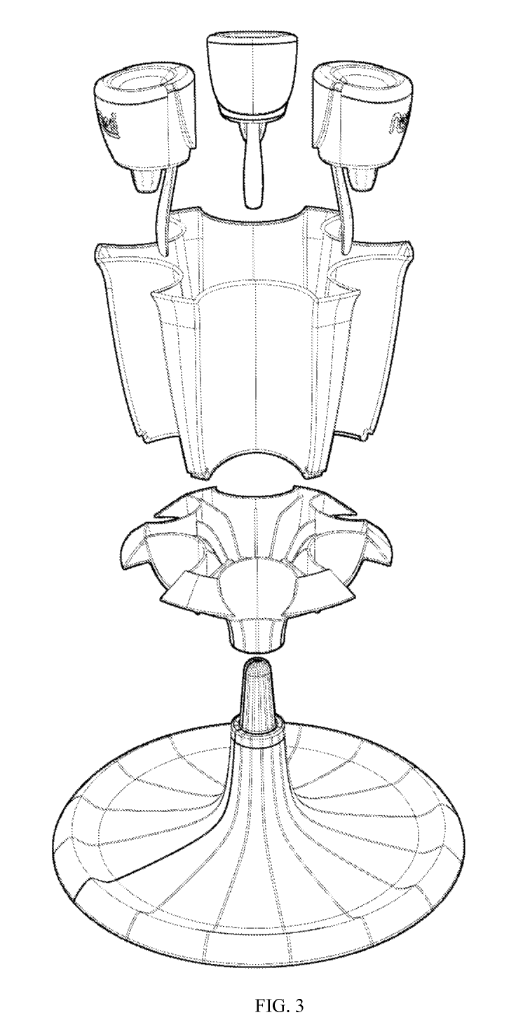

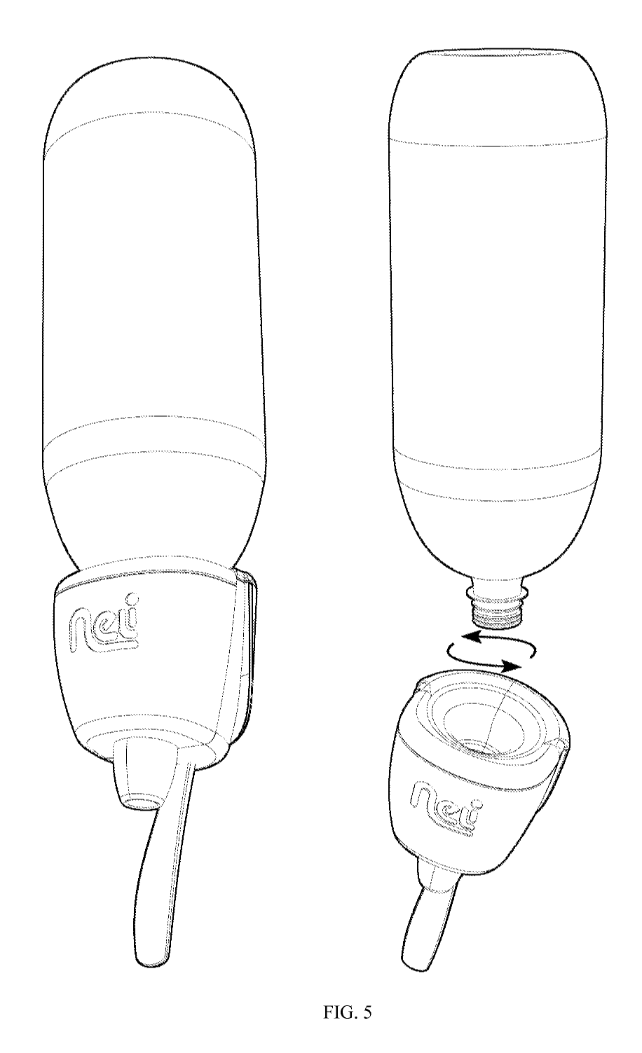

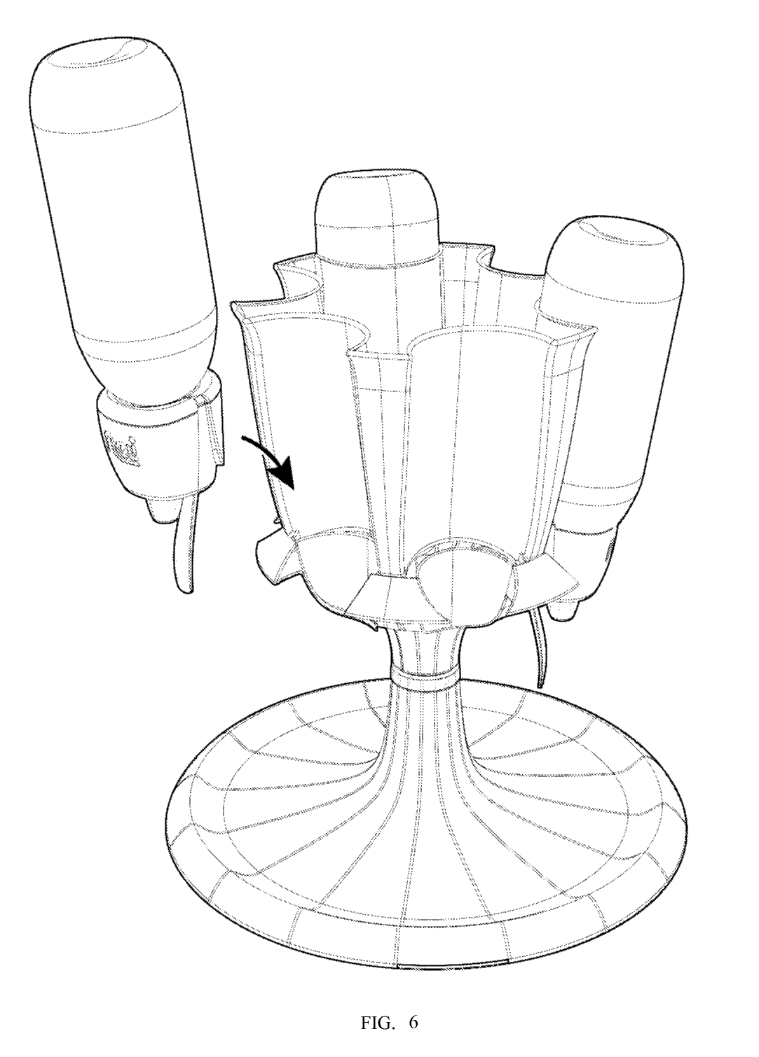

Referring now to FIGS. 3 and 5, an embodiment of a head assembly will be discussed. The embodiment of the head assembly may have threads for attaching to fluid containers having corresponding threads. As is illustrated in FIG. 3, a head assembly may comprise a push lever for actuating the valve in the head assembly and may comprise a nozzle for controlling fluid flow.

Illustrated in FIG. 6 is an embodiment of an ice bin or ice bowl. The ice bin may have relieved portions for accommodating the placement of liquid containers therein. A bottle surround may be one such relieved portion and may be sized and shaped for accommodating the placement of a bottle or liquid container therein. An ice bowl may be configured with a cup surround relieved portion shaped and sized to accommodate cups or beverageware generally therein. An ice bowl may further comprise other features for the storage of parts when taken down or disassembled.

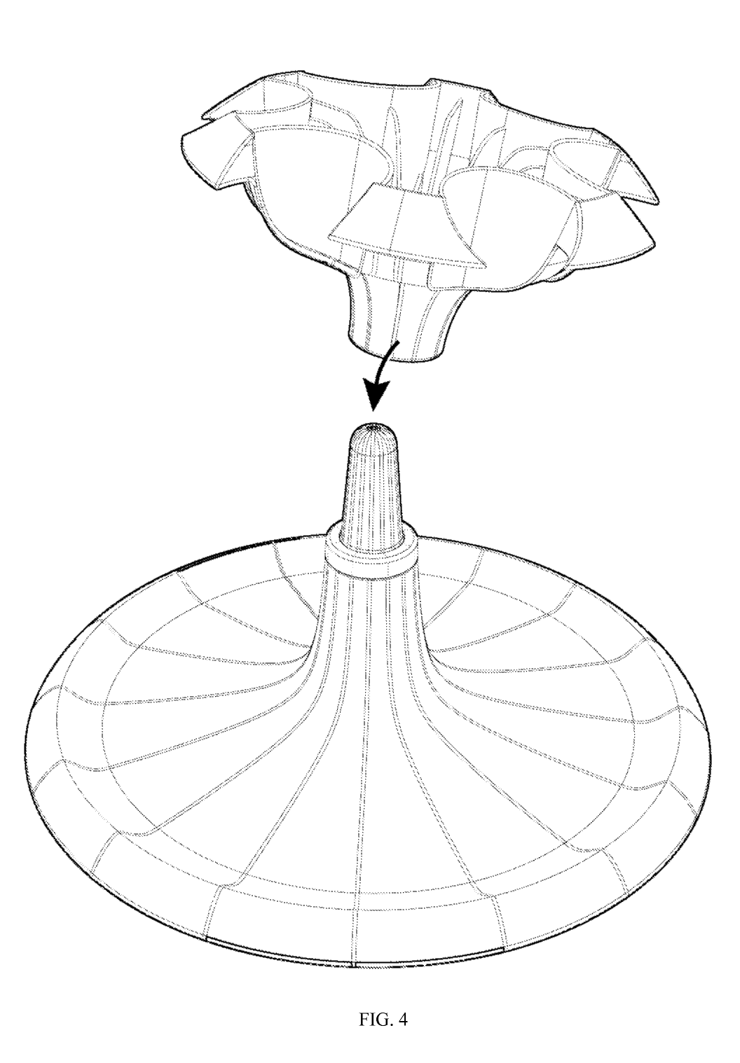

Referring now to FIGS. 3 and 4, an embodiment of a rack will be discussed. The rack may be configured with a dispenser catch for releasably locking a head assembly therein. A rack may be configured to comprise a cup catch therein. The rack may comprise an attachment feature therein for attaching to a stand or support. The attachment feature may be of male and female configuration as known in the art.

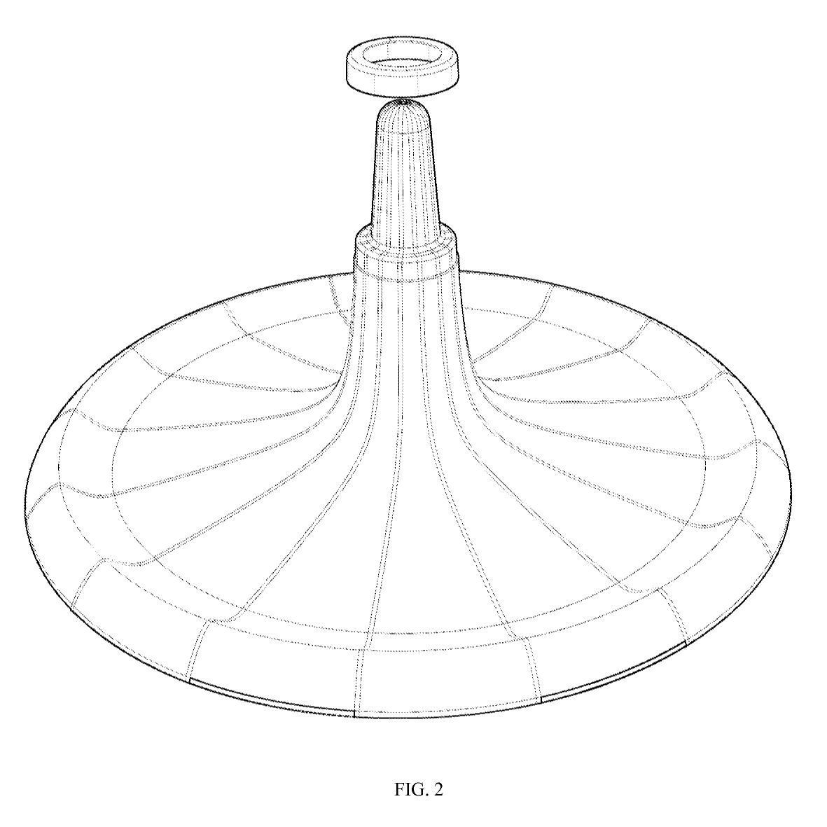

Illustrated in FIG. 2 is an embodiment of a base. As illustrated, an embodiment may comprise an attachment structure for attaching to a rack. The base may be configured for the use of bushings so as to allow for an easy rotation of the rack relative to the base. A rack may not rotate relative to said base or may rotate without the aid of bushings.

Illustrated in FIG. 3 is an exploded view of the components of a liquid dispensing system. The features of the apparatus may be assembled and utilized together as shown in the figure and as described herein.

Illustrated in FIG. 4 is an assembly view of a rack, bushing, and base. As can be seen in the figure, a bushing may be fit over a male attachment feature and allow for the easy rotation of a rack relative to said base. The rack may be fitted with a corresponding bushing. The rack and base maybe fitted without a bushing. The rack and base may not rotate relative to each other.

Illustrated in FIG. 5 is an embodiment of a dispenser head as being used with a threaded liquid container. As can be seen in the illustration, a dispenser head may be threaded onto a liquid container in the inverted orientation with the liquid container in the upright orientation. A valve in the dispenser head may be employed to keep the fluid in the liquid container when the assembly is inverted for use and placed in the rack. A lever can be actuated by a user to open the valve.

With reference primarily to FIG. 6, an embodiment of a liquid dispensing system is illustrated. As can be seen in the illustration a head assembly/valve attached to a fluid container is placed in a rack and held therein with corresponding attachment structures.

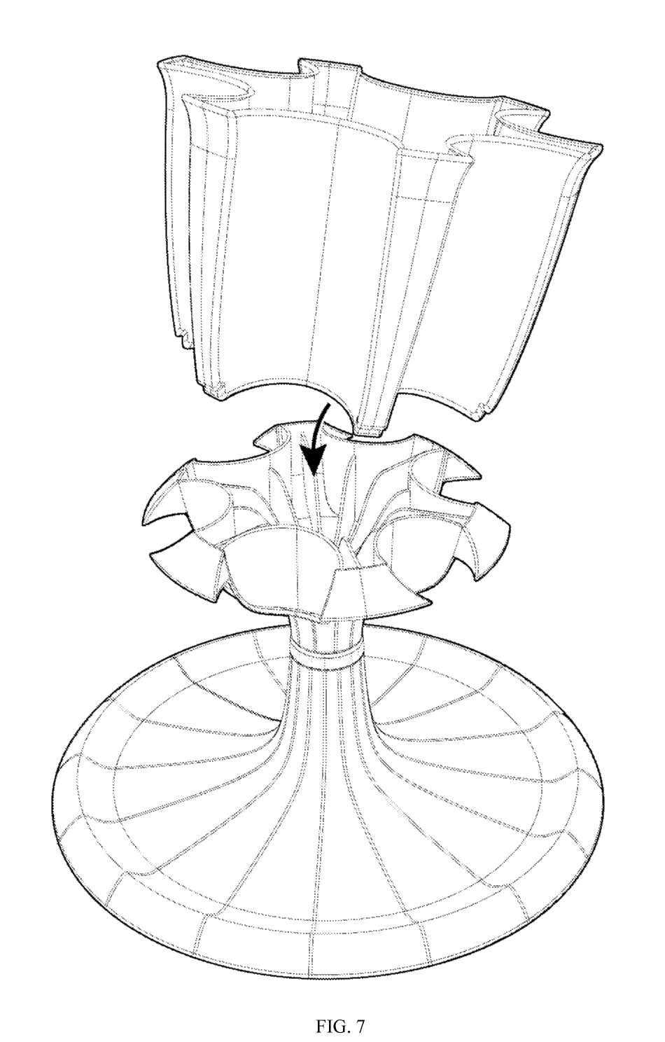

With reference to FIG. 7, an embodiment of a fluid dispensing system will be discussed. As illustrated, an ice bowl may be configured with a locking feature for securably attaching said ice bowl to a rack in the system.

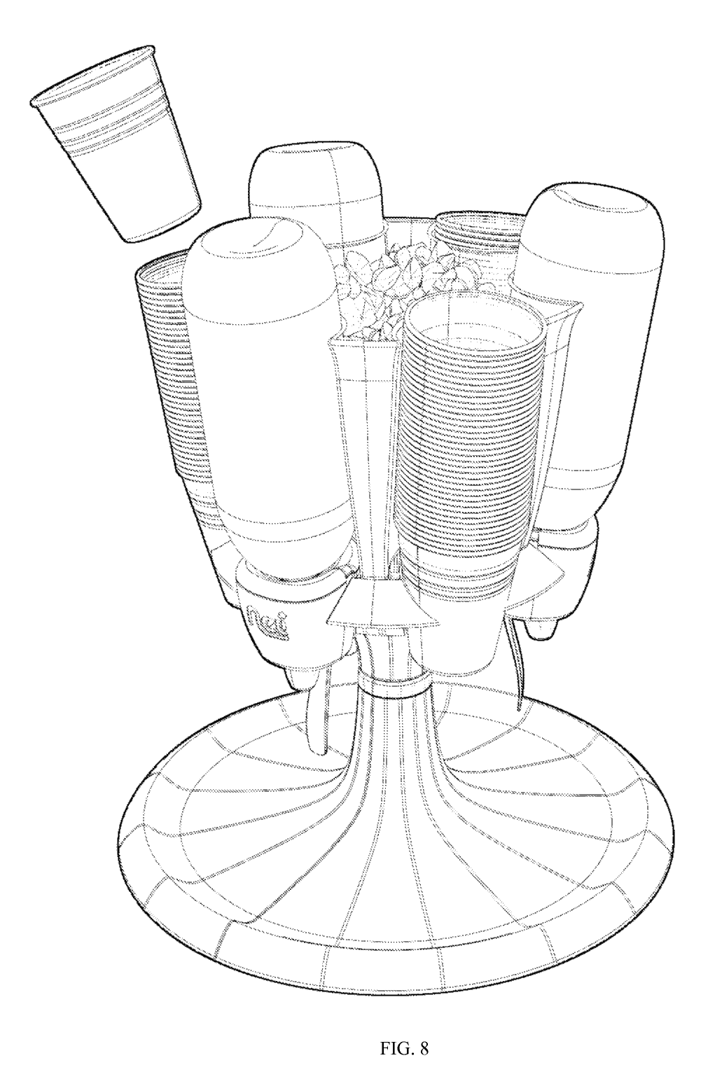

Referring now to FIG. 8, an embodiment of a system for dispensing liquids will be discussed relative to holding cups therein. As can be seen in the illustration, cups may be placed onto the system for convenience and tidiness. The cup catch may hold many varied sizes of cups.

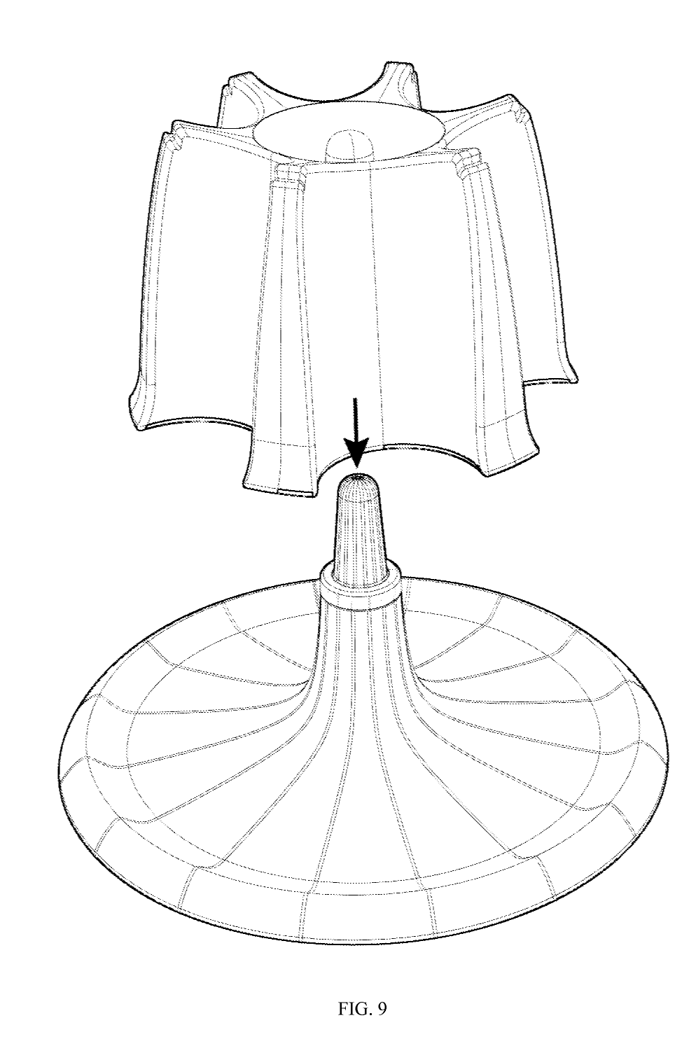

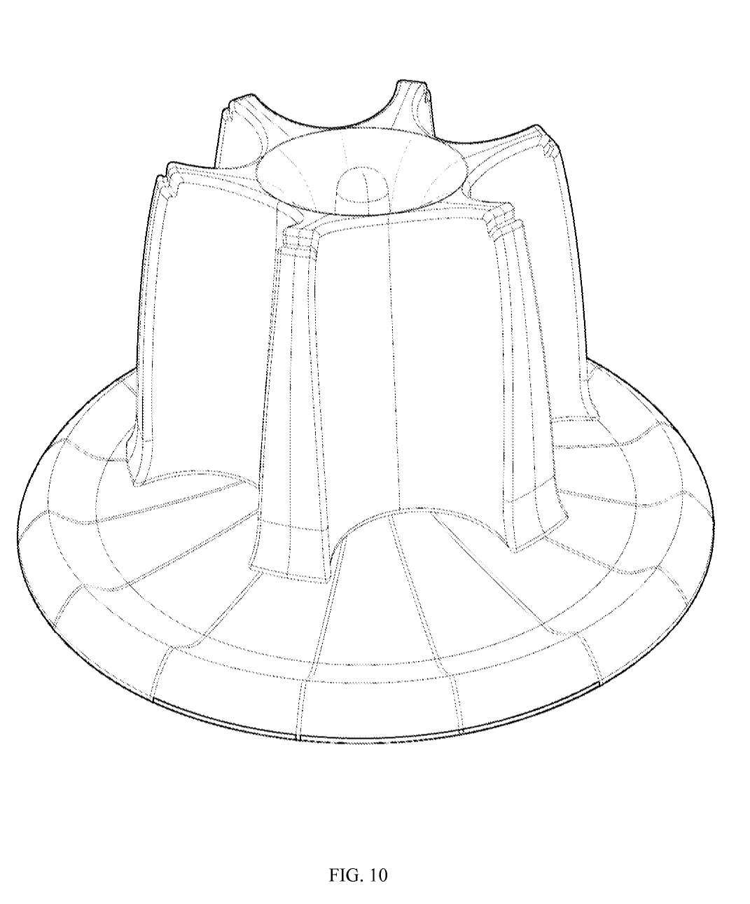

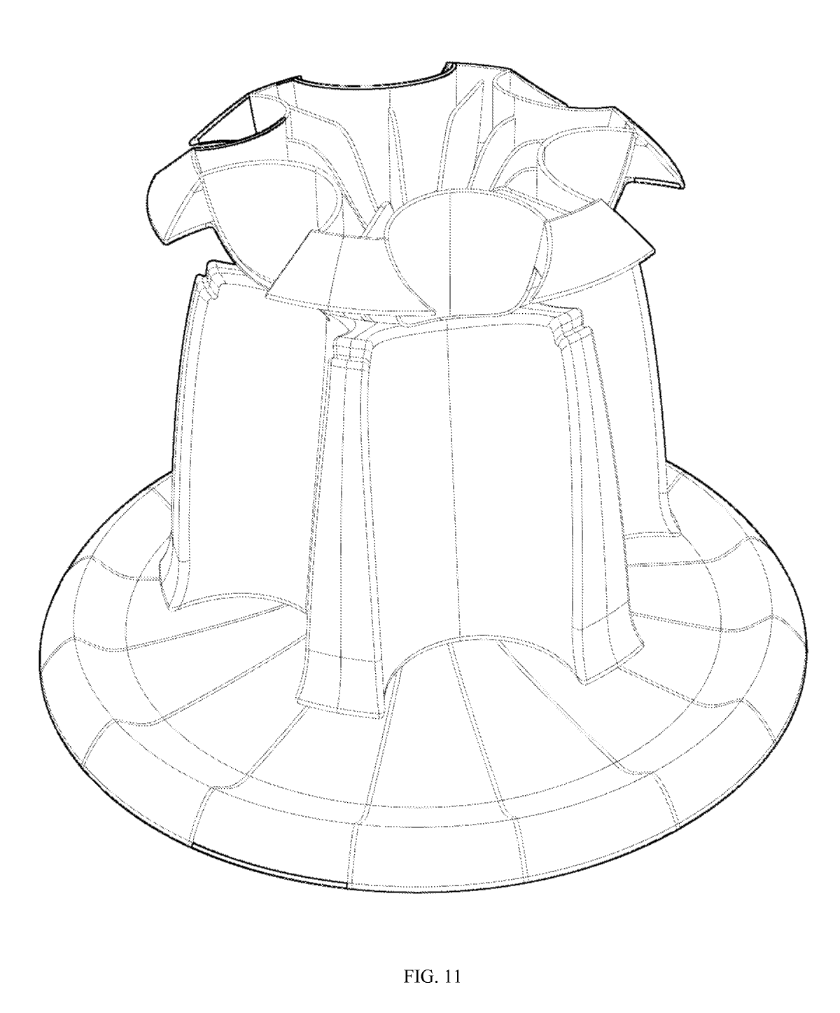

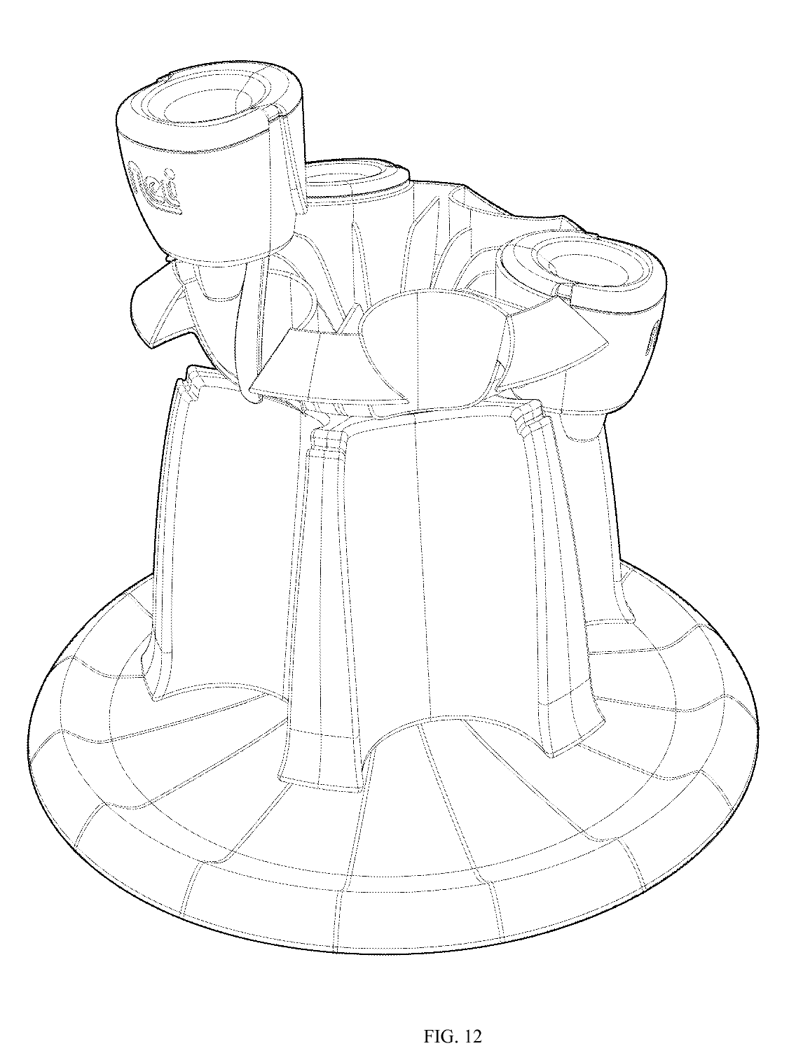

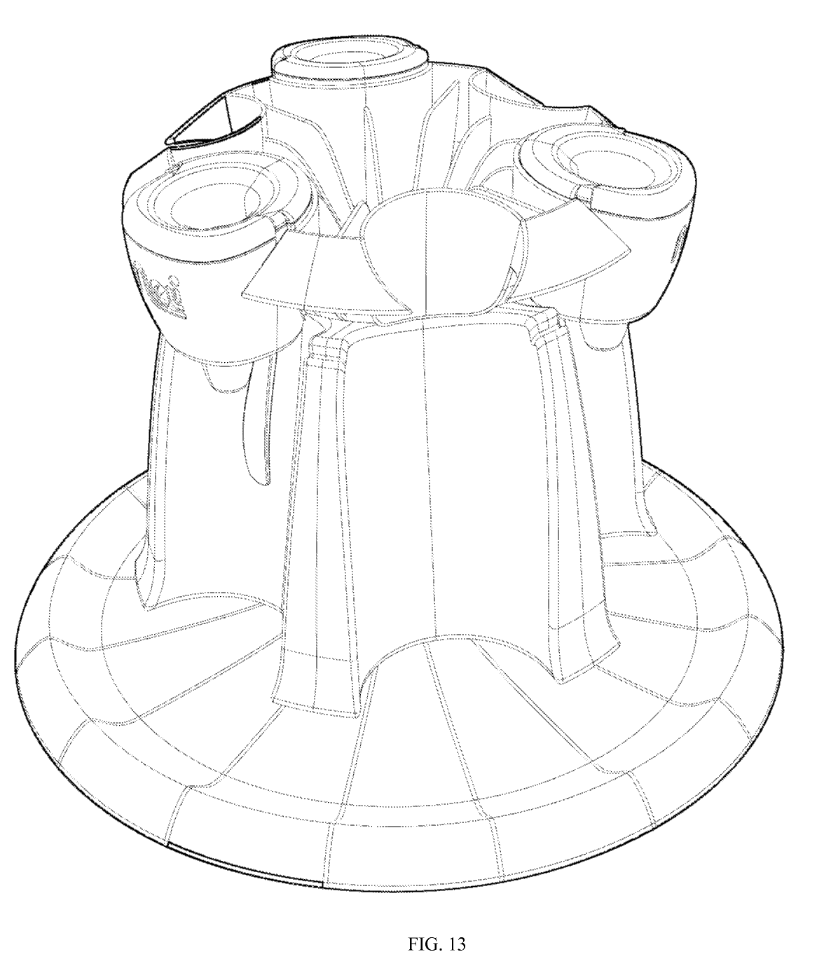

With reference to FIGS. 9-13, a method of disassembly for storage will be discussed. The system may be disassembled and made ready for storage. The components may be configured so as to nest into each other to occupy less space and for convenient storage.

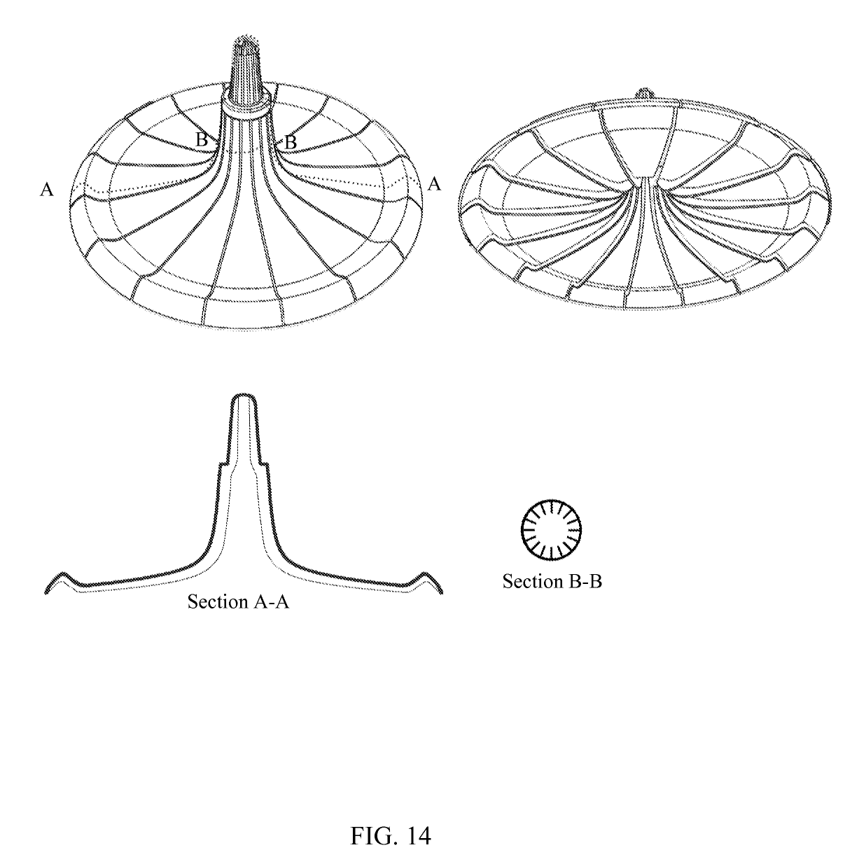

Illustrated in FIG. 14 is an embodiment of a base component. The embodiment may comprise rib features for added strength. Components of the system may be molded or milled out of any suitable material.

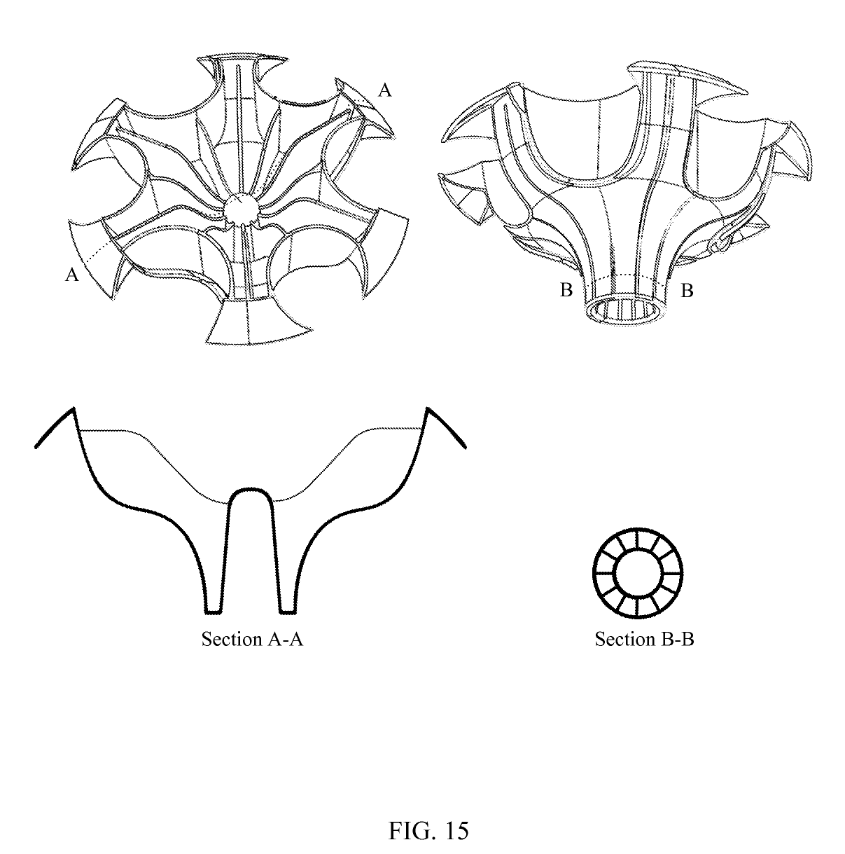

Illustrated in FIG. 15 is an embodiment of a rack component. The embodiment may comprise rib features for added strength. Components of the system may be molded or milled out of any suitable material.

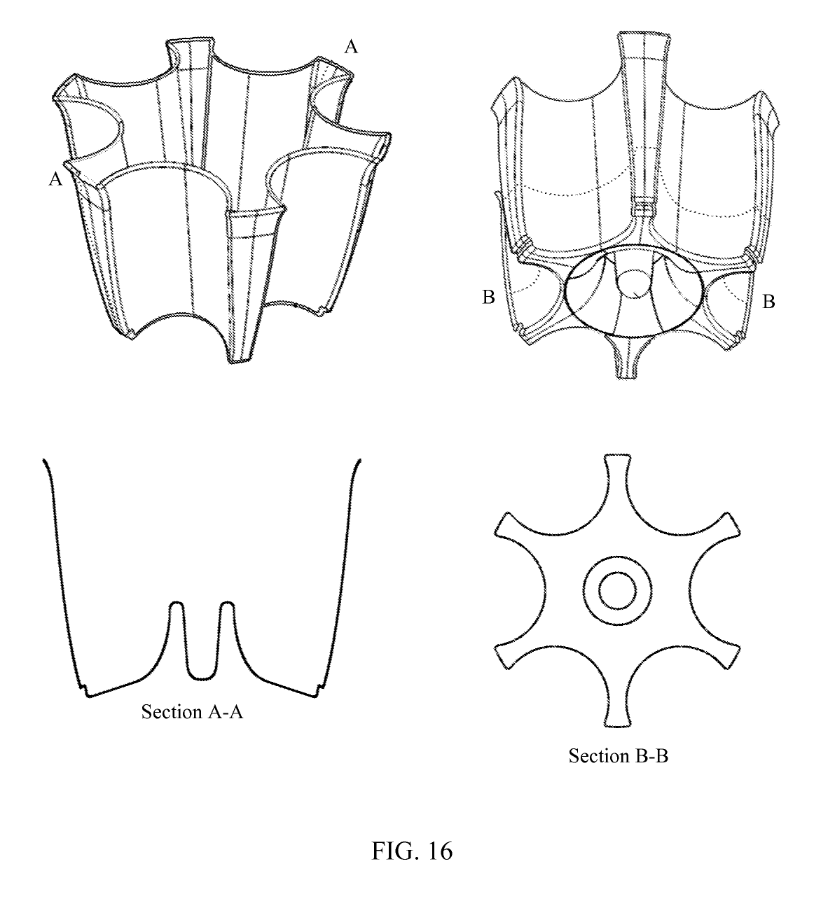

Illustrated in FIG. 16 is an embodiment of a ice bowl component. The embodiment may comprise rib features for added strength. Components of the system may be molded or milled out of any suitable material.

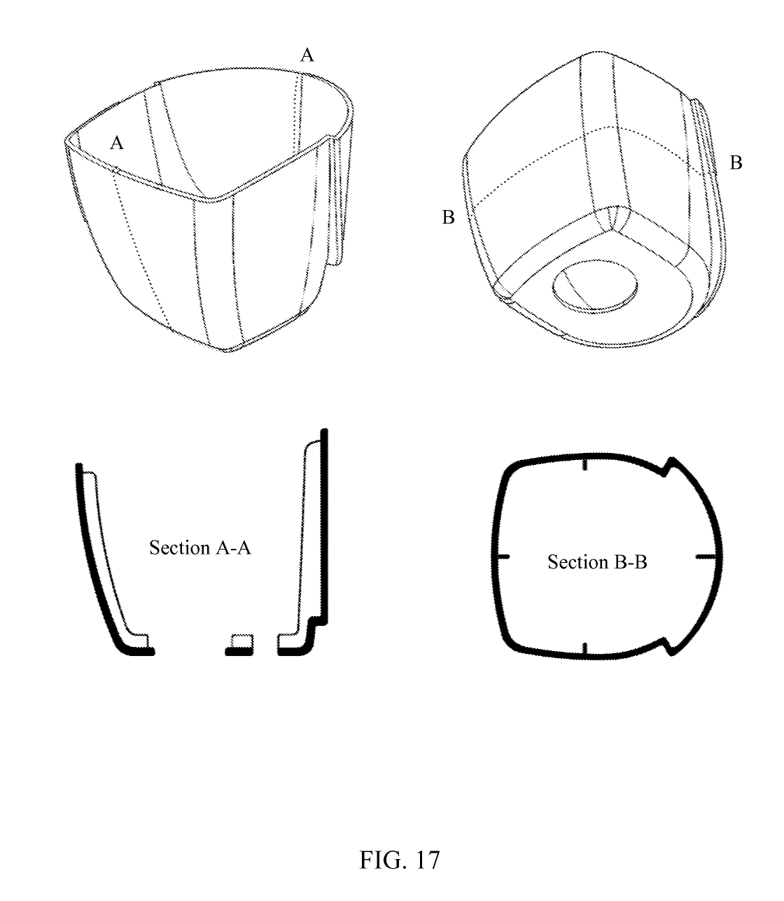

Illustrated in FIG. 17 is an embodiment of a head assembly component. The embodiment may comprise rib features for added strength. Components of the system may be molded or milled out of any suitable material.

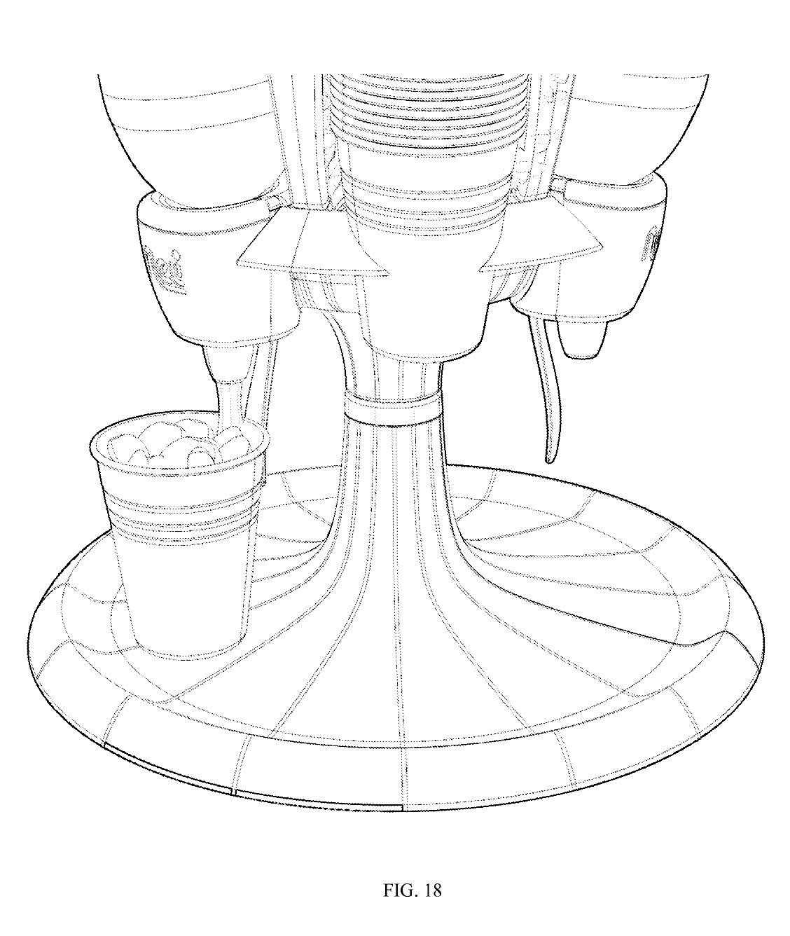

Illustrated in FIG. 18 is an embodiment of a liquid dispensing system in use. A user may take a cup and position it below a head assembly and actuate a valve thereby allowing a liquid to flow from the liquid container in to said cup. When the user ceases to actuate the valve the flow of fluid will stip.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the disclosure reflects, inventive aspects lie in less than all features of a single foregoing disclosed embodiment.

It is to be understood that the above-described arrangements are only illustrative of the application of the principles of the disclosure. Numerous modifications and alternative arrangements may be devised by those skilled in the art without departing from the spirit and scope of the disclosure and the disclosure is intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for dispensing fluids comprising:
a base comprising a first attachment feature;
a rack comprising a second attachment feature that opposes and corresponds with the first attachment feature; and
a head assembly comprising a mechanical attachment mechanism for attaching, sealing and retaining at least one container of fluid, wherein the head assembly further comprises at least one dispensing valve and a lever, wherein the at least one dispensing valve is configured and arranged for controlling the flow of fluids from the container.

2. The apparatus of claim 1, wherein the apparatus further comprises an ice bowl having a recessed area for holding ice and at least one cutout for receiving a container therein.

3. The apparatus of claim 1, wherein the dispensing valve comprises threads for attaching to corresponding threads of the container.

4. The apparatus of claim 1, wherein the dispensing valve attaches to the container via a friction fit.

5. The apparatus of claim 1, wherein the dispensing valves are threaded and correspond with threads on the container.

6. The apparatus of claim 1, wherein the rack is configured and dimensioned to hold a plurality of liquid containers.

7. The apparatus of claim 1, wherein the head assembly comprises a dispenser head that is removable from the head assembly without disassembly, thereby allowing easy and quick liquid container exchanges.

8. The apparatus of claim 1, wherein the stand is a single post that fits into a corresponding female feature of the rack.

9. The apparatus of claim 1, wherein the stand supports an upper assembly to permit said upper assembly to rotate relative to the stand.

10. The apparatus of claim 9, wherein a bushing separates said stand from said upper assembly, thereby reducing friction during rotation.
